(19) United States
(12) Patent Application Publication
(10) Pub. No.: US 2024/0245253 A1
(43) Pub. Date: Jul. 25, 2024

(54) CORDLESS COFFEE MAKING DEVICE AND METHOD OF USE

(71) Applicant: Katie Jo Blau, Remer, MN (US)

(72) Inventor: Katie Jo Blau, Remer, MN (US)

(21) Appl. No.: 18/101,331

(22) Filed: Jan. 25, 2023

(51) Int. Cl. A47J 31/00; A23F 5/26; A47J 31/057; A47J 31/06; A47J 31/44; A47J 31/52; A47J 31/54; B65D 25/04; B65D 25/28; B65D 51/24

(52) U.S. Cl. CPC A47J 31/005; A23F 5/26; A47J 31/0573; A47J 31/06; A47J 31/4439; A47J 31/4467; A47J 31/52; A47J 31/542; B65D 25/04; B65D 25/2808; B65D 51/242

(57) ABSTRACT

A cordless coffee making device for brewing coffee without accessing a power grid includes a housing having a reservoir, for addition of water, a brewing compartment, for addition of a carafe and a basket that contains coffee grounds, and a power compartment. A pipe is attached to and extends between a bottom of the reservoir and an upper end of the brewing compartment. A heater is positioned in-line with the pipe is operationally engaged to a switch. A first connector in the power compartment is engaged to the switch and is complementary to a second connector of a battery that can selectively power a plurality of implements, wherein each implement comprises a first connector. The battery is attached by engaging the second connector to the first connector. The switch actuates the heater so that hot water flows through the pipe into the basket, causing coffee to collect in the carafe.

### CROSS-REFERENCE TO RELATED APPLICATIONS

### Not Applicable

### STATEMENT REGARDING FEDERALLY SPONSORED RESEARCH OR DEVELOPMENT

### Not Applicable

### THE NAMES OF THE PARTIES TO A JOINT RESEARCH AGREEMENT

### Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

### Not Applicable

### STATEMENT REGARDING PRIOR DISCLOSURES BY THE INVENTOR OR JOINT INVENTOR

### Not Applicable

### BACKGROUND OF THE INVENTION

### (1) Field of the Invention

The disclosure relates to coffee makers and more particularly pertains to a new coffee maker for brewing coffee without accessing a power grid. The present invention discloses a coffee maker that is powered by a battery which is capable of selectively powering the coffee maker or any one of a plurality of implements.

### (2) Description of Related Art Including Information Disclosed Under 37 CFR 1.97 and 1.98

The prior art relates to coffee makers, which may comprise coffee makers that are powered by external batteries, such as car batteries. Related prior art includes battery powered beverage dispensers. What is lacking in the prior art is a coffee maker that is powered by a battery that is selectively engageable to the coffee maker by insertion into a compartment, wherein the battery engages an electrical connector that is that same as that of a plurality of implements, thereby allowing the battery to selectively power either the coffee maker or one of the implements. Further lacking in the prior art is such a coffee maker having external lights, ports for charging auxiliary devices, and a radio.

### BRIEF SUMMARY OF THE INVENTION

An embodiment of the disclosure meets the needs presented above by generally comprising a housing, which defines an interior space. A plurality of walls is attached to the housing and defines a reservoir, a brewing compartment, and a power compartment within the interior space. An opening, a first cutout, and a second cutout are positioned in the housing and open into the brewing compartment, the reservoir, and the power compartment, respectively. The reservoir is configured for addition of water. A pipe is attached to and extends between a bottom of the reservoir and an upper end of the brewing compartment. A heater is positioned in-line with the pipe. A switch is attached to the housing and is operationally engaged to the heater. A basket is selectively attachable to the upper end of the brewing compartment so that the basket is positioned to receive hot water from the pipe. The basket is configured for insertion of a filter and coffee grounds. A carafe is selectively positionable in the brewing compartment below the basket.

A first connector is attached to the housing, is positioned in the power compartment, and is operationally engaged to the switch. The first connector is complementary to a second connector of a battery that is configured to selectively power a plurality of implements, wherein each implement comprises a first connector. The first connector is configured to selectively engage the second connector to operationally engage the battery to the switch. The switch is configured to be switched to actuate the heater to heat the water so that hot water flows through the pipe into the basket. The carafe is configured to receive coffee from the basket.

Another embodiment of the disclosure includes a method of brewing coffee absent access to a power grid. Provision steps entail providing coffee grounds and water, providing a cordless coffee making device, according to the disclosure above and providing a battery, which comprises a second connector that is complementary to the first connector. The battery is configured to selectively power a plurality of implements that each have a first connector, such as blowers, drills, saws, trimmers, fans, and the like.

Setup steps of the method are positioning the filter and the coffee grounds in the basket, attaching the basket to the upper end of the brewing compartment, positioning the carafe below the basket, and engaging the first connector to the second connector to operationally engage the battery to the switch. An operational step of the method is switching the switch to actuate the heater to heat the water so that hot water flows through the pipe into the basket so that coffee is collected in the carafe.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a cordless coffee making device according to an embodiment of the disclosure.

FIG. 2 is a front view of an embodiment of the disclosure.

FIG. 3 is a side view of an embodiment of the disclosure.

FIG. 4 is a rear view of an embodiment of the disclosure.

FIG. 5 is a cross-sectional view of an embodiment of the disclosure.

FIG. 6 is an isometric perspective view of an embodiment of the disclosure.

FIG. 7 is a block diagram of an embodiment of the disclosure.

FIG. 8 is a flow diagram for a method utilizing an embodiment of the disclosure.

### DETAILED DESCRIPTION OF THE INVENTION

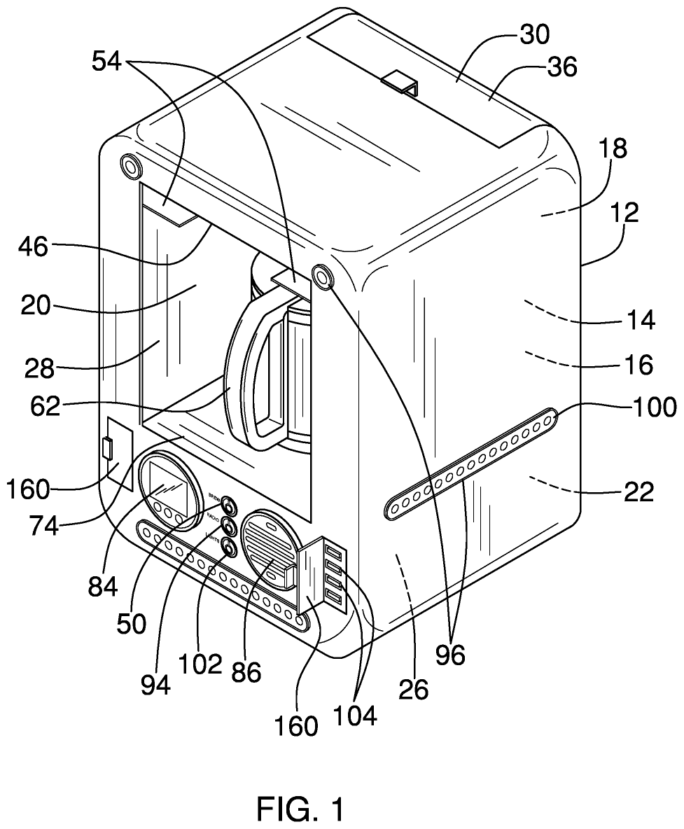

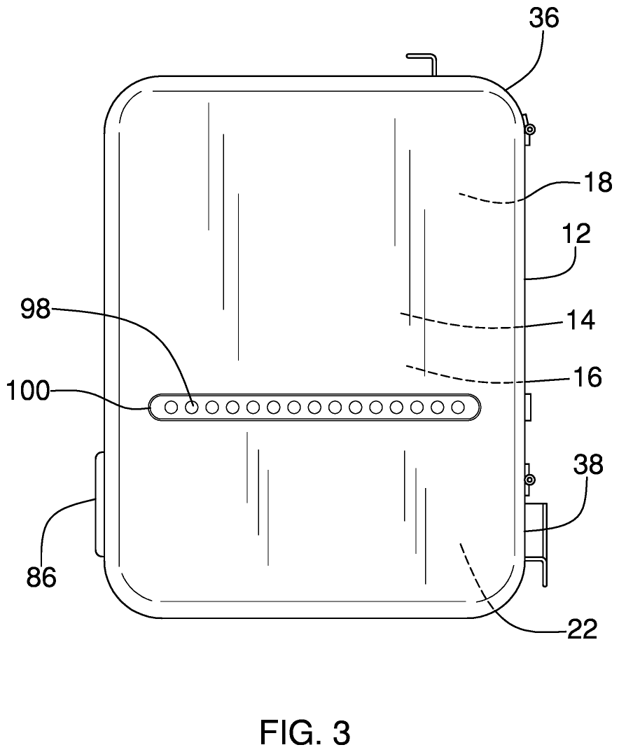

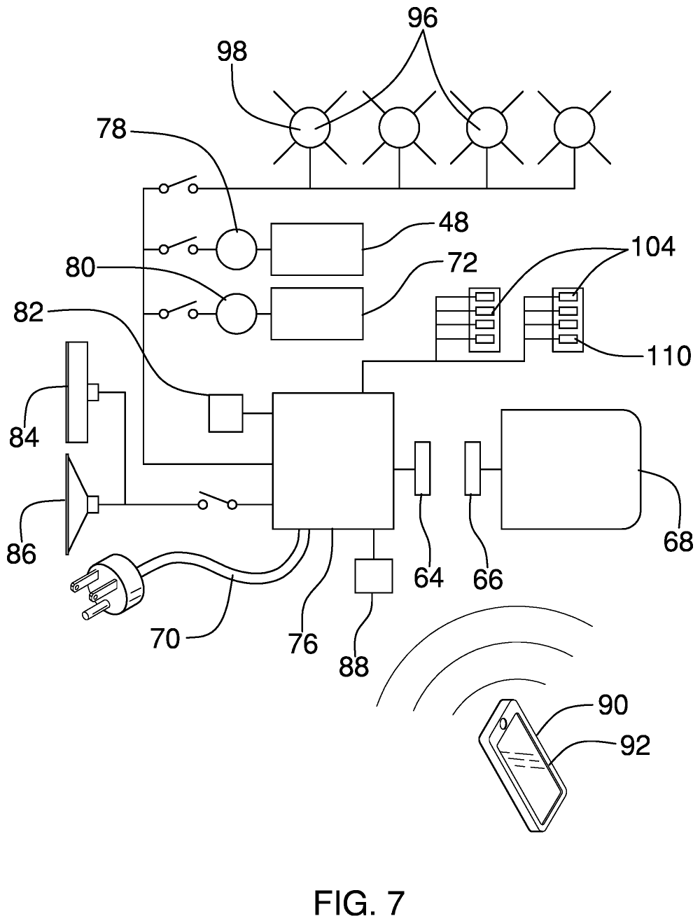

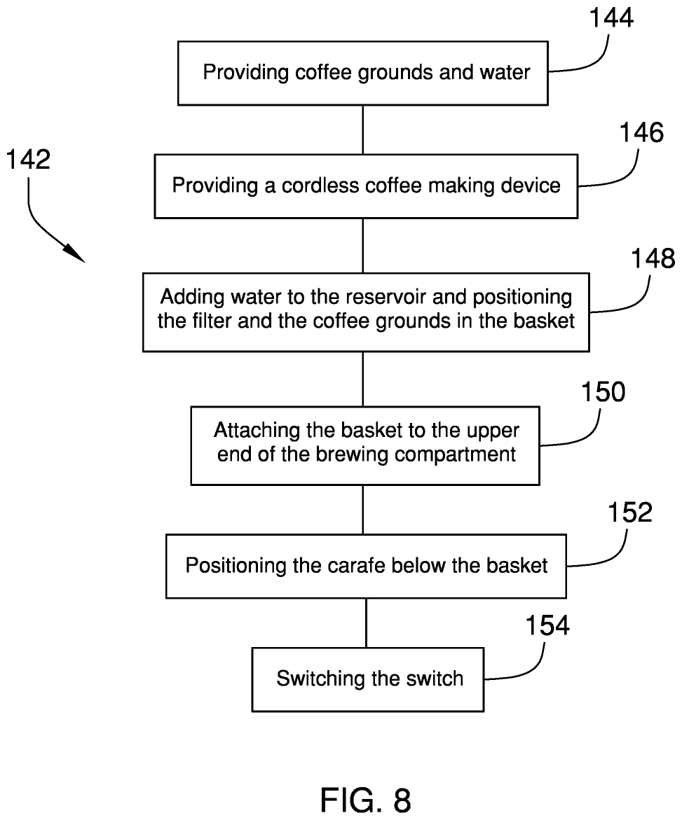

With reference now to the drawings, and in particular to FIGS. 1 through 8 thereof, a new coffee maker embodying the principles and concepts of an embodiment of the disclosure and generally designated by the reference numeral 10 will be described.

As best illustrated in FIGS. 1 through 8, the cordless coffee making device 10 generally comprises a housing 12, which defines an interior space 14 and which is substantially impermeable to water. A plurality of walls 16 is attached to the housing 12 and defines a reservoir 18, a brewing compartment 20, a power compartment 22, a cord compartment 24, and an electronics compartment 26 within the interior space 14. An opening 28, a first cutout 30, a second cutout 32, and a third cutout 34 are positioned in the housing 12 and open into the brewing compartment 20, the reservoir 18, the power compartment 22, and the cord compartment 24, respectively. A first panel 36, a second panel 38, and a third panel 40 are hingedly attached to the housing 12 and are positioned to selectively close the first cutout 30, the second cutout 32, and the third cutout 34, respectively.

The reservoir 18 is configured for addition of water. A pipe 42 is attached to and extends between a bottom 44 of the reservoir 18 and an upper end 46 of the brewing compartment 20. A heater 48 is positioned in-line with the pipe 42. A switch 50 is attached to the housing 12 and is operationally engaged to the heater 48. A basket 52 is selectively attachable to the upper end 46 of the brewing compartment 20 so that the basket 52 is positioned to receive hot water from the pipe 42.

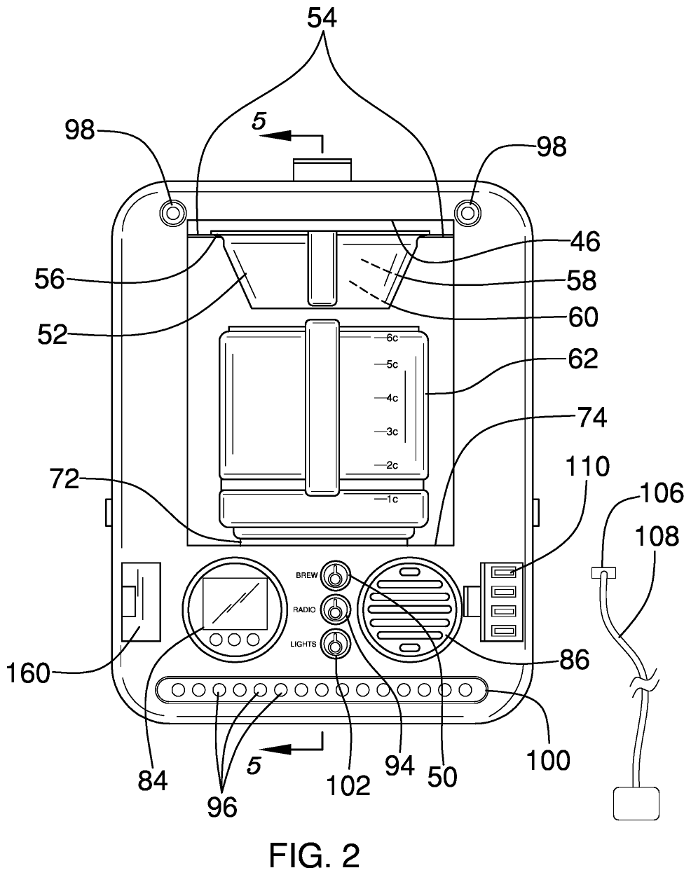

As shown in FIG. 2, a pair of rails 54 is attached to the upper end 46 of the brewing compartment 20 and is positioned for selective insertion of a rim 56 of the basket 52 to removably attach the basket 52 to the upper end 46 of the brewing compartment 20. The basket 52 is configured for insertion of a filter 58 and coffee grounds 60, as per prior art coffee makers. The hot water from the pipe 42 may be distributed over the coffee grounds 60 by means well known to those skilled in the art of coffee makers, such as distribution heads, screens, or the like. The present invention also anticipates the basket 52 being configured for single servings using pods of coffee grounds, or the like.

A carafe 62 is selectively positionable in the brewing compartment 20 below the basket 52, as shown in FIG. 2. Such carafes are well known in the prior art and may comprise glass, stainless steel, or the like, and also may be insulated.

A first connector 64 is attached to the housing 12, is positioned in the power compartment 22, and is operationally engaged to the switch 50. The first connector 64 is complementary to a second connector 66 of a battery 68 that is configured to selectively power a plurality of implements, wherein each implement comprises a first connector 64. A number of manufacturers offer sets of implements wherein each implement is compatible with a single battery 68. The present invention anticipates the first connector 64 being of a variety of configurations that are compatible with the respective configurations of the second connectors 66 of the batteries 68 offered by the various manufacturers.

The present invention also anticipates the cordless coffee making device 10 including a battery 68. The first connector 64 is configured to selectively engage the second connector 66 to operationally engage the battery 68 to the switch 50. The switch 50 is configured to be switched to actuate the heater 48 to heat the water so that hot water flows through the pipe 42 into the basket 52. The carafe 62 is configured to receive coffee from the basket 52.

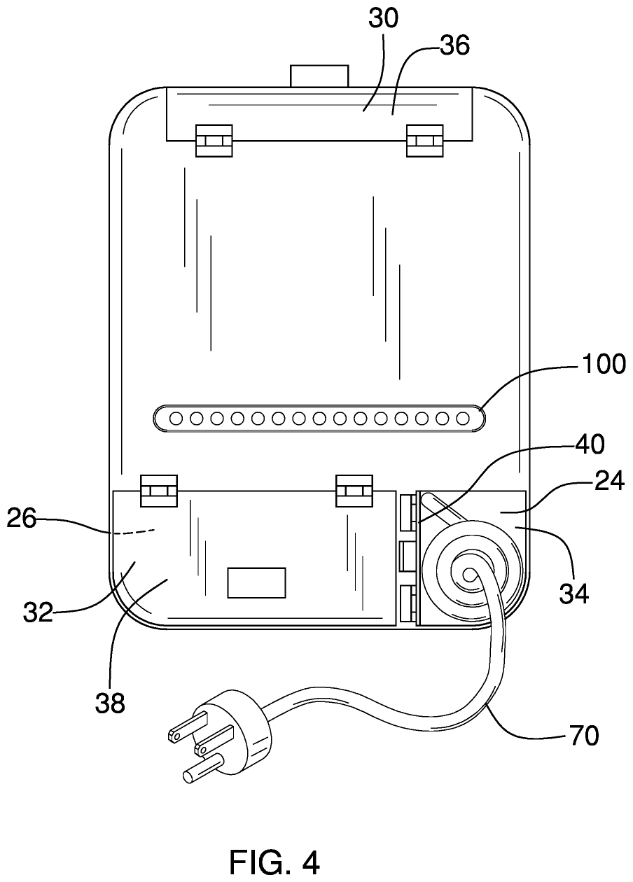

As shown in FIG. 4, a power cord 70 is positioned in and is selectively extensible from the cord compartment 24. The power cord 70 is operationally engaged to the first connector 64 and thus is configured to selectively engage the first connector 64 to a source of electrical current to charge the battery 68.

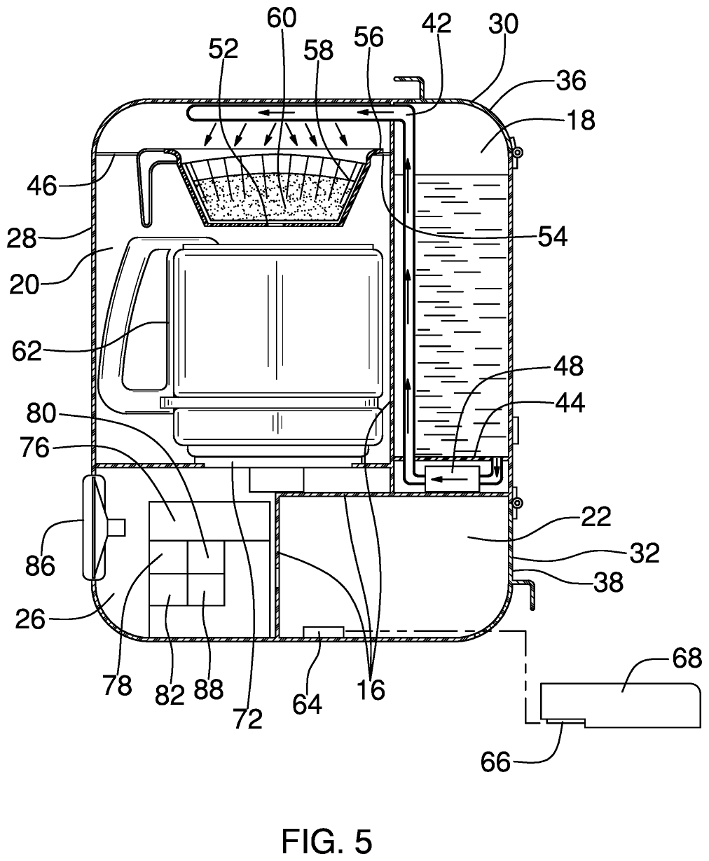

As shown in FIG. 5, the cordless coffee making device 10 may comprise a heating plate 72, which is attached to a lower end 74 of the brewing compartment 20 and which is operationally engaged to the switch 50. The heating plate 72 is configured to heat the coffee in the carafe 62, which is most useful when the carafe 62 comprises glass and is uninsulated.

A microprocessor 76 is attached to the housing 12, is positioned in the electronics compartment 26, and is operationally engaged to the switch 50, the first connector 64, the heater 48, and the heating plate 72. The microprocessor 76 thus is enabled to selectively actuate the heater 48 and the heating plate 72. A brew timer 78 and a warming timer 80 are attached to the housing 12, are positioned in the electronics compartment 26, and are operationally engaged to the microprocessor 76. The microprocessor 76 is enabled to actuate the brew timer 78 and the warming timer 80 to control an operational time for the heater 48 and the heating plate 72, respectively. For example, the warming timer 80 may have an operational time of two hours upon switching of the switch 50.

The cordless coffee making device 10 also may include a first receiver 82, a control screen 84, and a speaker 86. The first receiver 82, which is configured to receive radio waves, is attached to the housing 12, is positioned in the electronics compartment 26, and is operationally engaged to the microprocessor 76. The speaker 86 and the control screen 84 are attached to the housing 12 and are operationally engaged to the microprocessor 76. The control screen 84 is enabled to signal the microprocessor 76 to set a reception band for the first receiver 82, essentially selecting a radio station. The speaker 86 is configured to broadcast a radio signal that is received by the first receiver 82.

The cordless coffee making device 10 also may include a second receiver 88, which is attached to the housing 12, is positioned in the electronics compartment 26, and is operationally engaged to the microprocessor 76. The second receiver 88 is configured to pair with an electronic device 90 of a user, such as a cellphone 92. The second receiver 88 is configured to receive an audio file from the electronic device 90, which then can be broadcast by the speaker 86.

An audio button 94 is attached to the housing 12 and is operationally engaged to the microprocessor 76. The audio button 94 is configured to be depressed a first time to signal the microprocessor 76 to power the first receiver 82, the second receiver 88, and the control screen 84 and to be depressed a second time to deactuate the first receiver 82, the second receiver 88 and the control screen 84. The present invention anticipates the audio button 94 comprising other switching means, such as, but not limited to, slides, toggles, or the like.

The cordless coffee making device 10 also may include a plurality of bulbs 96, which is attached to the housing 12 and which is operationally engaged to the microprocessor 76. The microprocessor 76 thus is enabled to selectively actuate the plurality of bulbs 96 so that the plurality of bulbs 96 is configured to illuminate a space proximate to the housing 12. Each bulb 96 may comprise a light emitting diode 98, or other illumination means, such a phosphorescent lights, fluorescent lights, or the like. As shown in FIGS. 1-5, the light emitting diodes 98 are configured as strips 100 that are attached to the housing 12. Singular light emitting diodes 98 also may be attached to the housing 12, as shown in FIG. 2, wherein two light emitting diode 98 are positioned proximate to the upper end 46 of the brewing compartment 20.

A light button 102 is attached to the housing 12 and is operationally engaged to the microprocessor 76. The light button 102 is configured to be depressed a first time to signal the microprocessor 76 to power the plurality of bulbs 96 and to be depressed a second time to deactuate the plurality of bulbs 96. The present invention anticipates the light button 102 comprising other switching means, such as, but not limited to, slides, toggles, or the like.

The cordless coffee making device 10 also may include a plurality of ports 104, which is attached to the housing 12 and which is operationally engaged to the microprocessor 76. Each port 104 is configured for insertion of a plug 106 of a respective charging cord 108 to power or to charge an auxiliary device of the user. Each port 104 may comprise a Universal Serial Bus port 110, or other connecting means, such as, but not limited to, sockets for barrel connectors, Molex connectors, or the like. The plurality of ports 104 may be sealably closed by means of a flap 160, which is hingedly attached to the housing, to prevent entry of moisture.

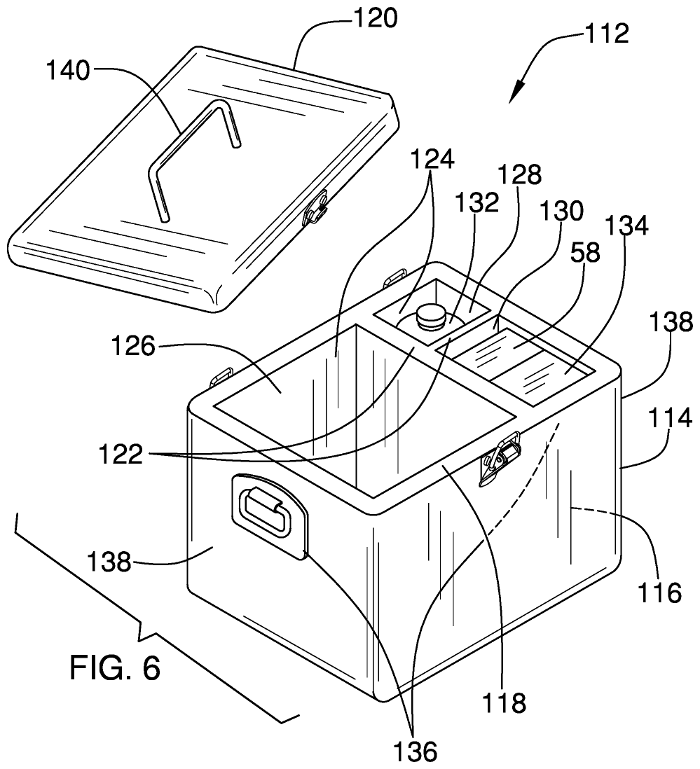

The cordless coffee making device 10 also may include a carrying case 112, as shown in FIG. 6. The carrying case 112 comprises a shell 114, which defines an internal space 116 and which has an open top 118. A lid 120 is selectively attachable to the shell 114 to close the open top 118. A plurality of divider panels 122 attached to the shell 114 and defines a plurality of chambers 124 within the internal space 116. The plurality of chambers 124 comprises a first chamber 126, a second chamber 128, and a third chamber 130, which are sized for stowage of the housing 12, a water container 132, and filters 58 and condiments 134, respectively. The first handles 136 of a pair of first handles 136 are attached singly to opposed ends 138 of the shell 114 and a second handle 140 is attached to the lid 120.

In use, the cordless coffee making device 10 enables a method of brewing coffee absent access to a power grid 142, such as may be desirable when traveling, camping, fishing, or the like, or at remote worksites. The method 142 comprises a first provision step 144, which entails providing coffee grounds 60 and water. A second provision step 146 of the method 142 is providing a cordless coffee making device 10, according to the specification above. A first setup step 148 of the method 142 is adding the water to the reservoir 18 and positioning the filter 58 and the coffee grounds 60 in the basket 52. A second setup step 150 of the method 142 is attaching the basket 52 to the upper end 46 of the brewing compartment 20. A third setup step 152 of the method 142 is positioning the carafe 62 below the basket 52.

A third provision step 154 of the method 142 is providing a battery 68, which comprises a second connector 66 that is complementary to the first connector 64. The battery 68 is configured to selectively power a plurality of implements, wherein each implement comprises a first connector 64. Such implements include, but are not limited to, blowers, drills, saws, trimmers, fans, and the like. A fourth setup step 156 of the method 142 is engaging the first connector 64 to the second connector 66 to operationally engage the battery 68 to the switch 50. An operational step 158 of the method 142 is switching the switch 50 to actuate the heater 48 to heat the water so that hot water flows through the pipe 42 into the basket 52 and so that coffee collects in the carafe 62.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cordless coffee making device comprising:
a housing defining an interior space;
a plurality of walls attached to the housing defining a reservoir, a brewing compartment, and a power compartment within the interior space;
a first cutout positioned in the housing and opening into the reservoir, wherein the reservoir is configured for addition of water;
a pipe attached to and extending between a bottom of the reservoir and an upper end of the brewing compartment;
a heater positioned in-line with the pipe;
a switch attached to the housing and operationally engaged to the heater;
an opening positioned in the housing and opening into the brewing compartment;
a basket selectively attachable to the upper end of the brewing compartment, such that the basket is positioned for receiving hot water from the pipe, wherein the basket is configured for insertion of a filter and coffee grounds;
a carafe selectively positionable in the brewing compartment below the basket;
a second cutout positioned in the housing and opening into the power compartment; and
a first connector attached to the housing, positioned in the power compartment, and operationally engaged to the switch, the first connector being complementary to a second connector of a battery configured for selectively powering a plurality of implements, wherein each implement of the plurality of implements comprises a first connector, wherein the first connector is configured for selectively engaging the second connector for operationally engaging the battery to the switch, wherein the switch is configured for being switched for actuating the heater for heating the water, such that hot water flows through the pipe into the basket, wherein the carafe is configured for receiving coffee from the basket.

2. The cordless coffee making device of claim 1, further including a pair of rails attached to the upper end of the brewing compartment, such that the pair of rails are positioned for selective insertion of a rim of the basket for removably attaching the basket to the upper end of the brewing compartment.

3. The cordless coffee making device of claim 1, further including:
a first panel hingedly attached to the housing and being positioned for selectively closing the first cutout; and
a second panel hingedly attached to the housing and being positioned for selectively closing the second cutout.

4. The cordless coffee making device of claim 1, further including:
the plurality of walls defining a cord compartment within the interior space;
a third cutout positioned in the housing and opening into the cord compartment;
a power cord positioned in and selectively extensible from the cord compartment, the power cord being operationally engaged to the first connector, wherein the power cord is configured for selectively engaging the first connector to a source of electrical current for charging the battery;
a third panel hingedly attached to the housing and being positioned for selectively closing the third cutout.

5. The cordless coffee making device of claim 1, further including a heating plate attached to a lower end of the brewing compartment and operationally engaged to the switch, wherein the heating plate is configured for heating the coffee in the carafe.

6. The cordless coffee making device of claim 5, further including:
the plurality of walls defining an electronics compartment within the interior space;
a microprocessor attached to the housing, positioned in the electronics compartment, and operationally engaged to the switch, the first connector, the heater, and the heating plate, such that the microprocessor is enabled for selectively actuating the heater and the heating plate;
a brew timer attached to the housing, positioned in the electronics compartment, and operationally engaged to the microprocessor, such that the microprocessor is enabled for actuating the brew timer for controlling an operational time for the heater; and
a warming timer attached to the housing, positioned in the electronics compartment, and operationally engaged to the microprocessor, such that the microprocessor is enabled for actuating the warming timer for controlling an operational time for the heating plate.

7. The cordless coffee making device of claim 6, further including:
a first receiver attached to the housing, positioned in the electronics compartment, and operationally engaged to the microprocessor, the first receiver being configured for receiving radio waves;
a control screen attached to the housing and operationally engaged to the microprocessor, such that the control screen is enabled for signaling the microprocessor for setting a reception band for the first receiver; and
a speaker attached to the housing and operationally engaged to the microprocessor, wherein the speaker is configured for broadcasting a radio signal received by the first receiver.

8. The cordless coffee making device of claim 7, further including a second receiver attached to the housing, positioned in the electronics compartment, and operationally engaged to the microprocessor, the second receiver being configured for pairing with an electronic device of a user, wherein the second receiver is configured for receiving an audio file from the electronic device for broadcast by the speaker.

9. The cordless coffee making device of claim 8, further including an audio button attached to the housing and operationally engaged to the microprocessor, wherein the audio button is configured for depressing a first time for signaling the microprocessor for powering the first receiver, the second receiver, and the control screen and for depressing a second time for deactuating the first receiver, the second receiver and the control screen.

10. The cordless coffee making device of claim 6, further including a plurality of bulbs attached to the housing and operationally engaged to the microprocessor, such that the microprocessor is enabled for selectively actuating the plurality of bulbs, wherein the plurality of bulbs is configured for illuminating a space proximate to the housing.

11. The cordless coffee making device of claim 10, wherein each bulb of the plurality of bulbs comprises a light emitting diode.

12. The cordless coffee making device of claim 10, further including a light button attached to the housing and operationally engaged to the microprocessor, wherein the light button is configured for depressing a first time for signaling the microprocessor for powering the plurality of bulbs and for depressing a second time for deactuating the plurality of bulbs.

13. The cordless coffee making device of claim 6, further including a plurality of ports attached to the housing and operationally engaged to the microprocessor, wherein each port of the plurality of ports is configured for insertion of a plug of a respective charging cord for powering or charging an auxiliary device of a user.

14. The cordless coffee making device of claim 13, wherein each port of the plurality of ports comprises a Universal Serial Bus port.

15. The cordless coffee making device of claim 1, further including a carrying case comprising:
a shell defining an internal space, the shell having an open top;
a lid selectively attachable to the shell for closing the open top; and
a plurality of divider panels attached to the shell defining a plurality of chambers within the internal space, the plurality of chambers comprising:
a first chamber sized for stowage of the housing,
a second chamber sized for stowage of a water container, and
a third chamber sized for stowage of filters and condiments.

16. The cordless coffee making device of claim 15, further including:
a pair of first handles attached singly to opposed ends of the shell; and
a second handle attached to the lid.

17. The cordless coffee making device of claim 1, wherein the housing is substantially impermeable to water.

18. A method of brewing coffee absent access to a power grid comprising the steps of:
providing coffee grounds and water;
providing a cordless coffee making device comprising:
a housing defining an interior space,
a plurality of walls attached to the housing defining a reservoir, a brewing compartment, and a power compartment within the interior space,
a first cutout positioned in the housing and opening into the reservoir, wherein the reservoir is configured for addition of water,
a pipe attached to and extending between a bottom of the reservoir and an upper end of the brewing compartment,
a heater positioned in-line with the pipe,
a switch attached to the housing and operationally engaged to the heater,
an opening positioned in the housing and opening into the brewing compartment,
a basket selectively attachable to the upper end of the brewing compartment, such that the basket is positioned for receiving hot water from the pipe,
a carafe selectively positionable in the brewing compartment below the basket,
a second cutout positioned in the housing and opening into the power compartment, and
a first connector attached to the housing, positioned in the power compartment, and operationally engaged to the switch;
adding water to the reservoir and positioning the filter and the coffee grounds in the basket;
attaching the basket to the upper end of the brewing compartment;
positioning the carafe below the basket;
providing a battery comprising a second connector complementary to the first connector, wherein the battery is configured for selectively powering a plurality of implements, wherein each implement of the plurality of implements comprises a first connector;
engaging the first connector to the second connector to operationally engage the battery to the switch; and
switching the switch to actuate the heater to heat the water, such that hot water flows through the pipe into the basket, such that coffee is collected in the carafe.

19. A cordless coffee making device comprising:
a housing defining an interior space, the housing being substantially impermeable to water;
a plurality of walls attached to the housing defining a reservoir, a brewing compartment, a power compartment, an electronics compartment, and cord compartment within the interior space;
a first cutout positioned in the housing and opening into the reservoir, wherein the reservoir is configured for addition of water;
a first panel hingedly attached to the housing and being positioned for selectively closing the first cutout;
a pipe attached to and extending between a bottom of the reservoir and an upper end of the brewing compartment;
a heater positioned in-line with the pipe;
a switch attached to the housing and operationally engaged to the heater;
an opening positioned in the housing and opening into the brewing compartment;
a basket selectively attachable to the upper end of the brewing compartment, such that the basket is positioned for receiving hot water from the pipe, wherein the basket is configured for insertion of a filter and coffee grounds,
a pair of rails attached to the upper end of the brewing compartment, such that the pair of rails are positioned for selective insertion of a rim of the basket for removably attaching the basket to the upper end of the brewing compartment;
a carafe selectively positionable in the brewing compartment below the basket,
a second cutout positioned in the housing and opening into the power compartment;
a second panel hingedly attached to the housing and being positioned for selectively closing the second cutout;
a first connector attached to the housing, positioned in the power compartment, and operationally engaged to the switch, the first connector being complementary to a second connector of a battery configured for selectively powering a plurality of implements, wherein each implement of the plurality of implements comprises a first connector, wherein the first connector is configured for selectively engaging the second connector for operationally engaging the battery to the switch, wherein the switch is configured for being switched for actuating the heater for heating the water, such that hot water flows through the pipe into the basket, wherein the carafe is configured for receiving coffee from the basket,
a third cutout positioned in the housing and opening into the cord compartment;
a power cord positioned in and selectively extensible from the cord compartment, the power cord being operationally engaged to the first connector, wherein the power cord is configured for selectively engaging the first connector to a source of electrical current for charging the battery;
a third panel hingedly attached to the housing and being positioned for selectively closing the third cutout;
a heating plate attached to a lower end of the brewing compartment and operationally engaged to the switch, wherein the heating plate is configured for heating the coffee in the carafe;
a microprocessor attached to the housing, positioned in the electronics compartment, and operationally engaged to the switch, the first connector, the heater, and the heating plate, such that the microprocessor is enabled for selectively actuating the heater and the heating plate;
a brew timer attached to the housing, positioned in the electronics compartment, and operationally engaged to the microprocessor, such that the microprocessor is enabled for actuating the brew timer for controlling an operational time for the heater;
a warming timer attached to the housing, positioned in the electronics compartment, and operationally engaged to the microprocessor, such that the microprocessor is enabled for actuating the warming timer for controlling an operational time for the heating plate;
a first receiver attached to the housing, positioned in the electronics compartment, and operationally engaged to the microprocessor, the first receiver being configured for receiving radio waves;
a control screen attached to the housing and operationally engaged to the microprocessor, such that the control screen is enabled for signaling the microprocessor for setting a reception band for the first receiver;
a speaker attached to the housing and operationally engaged to the microprocessor, wherein the speaker is configured for broadcasting a radio signal received by the first receiver;
a second receiver attached to the housing, positioned in the electronics compartment, and operationally engaged to the microprocessor, the second receiver being configured for pairing with an electronic device of a user, wherein the second receiver is configured for receiving an audio file from the electronic device for broadcast by the speaker;
an audio button attached to the housing and operationally engaged to the microprocessor, wherein the audio button is configured for depressing a first time for signaling the microprocessor for powering the first receiver, the second receiver, and the control screen and for depressing a second time for deactuating the first receiver, the second receiver and the control screen;
a plurality of bulbs attached to the housing and operationally engaged to the microprocessor, such that the microprocessor is enabled for selectively actuating the plurality of bulbs, wherein the plurality of bulbs is configured for illuminating a space proximate to the housing, each bulb of the plurality of bulbs comprising a light emitting diode;
a light button attached to the housing and operationally engaged to the microprocessor, wherein the light button is configured for depressing a first time for signaling the microprocessor for powering the plurality of bulbs and for depressing a second time for deactuating the plurality of bulbs;
a plurality of ports attached to the housing and operationally engaged to the microprocessor, wherein each port of the plurality of ports is configured for insertion of a plug of a respective charging cord for powering or charging an auxiliary device of the user, each port of the plurality of ports comprising a Universal Serial Bus port; and
a carrying case comprising:
a shell defining an internal space, the shell having an open top,
a lid selectively attachable to the shell for closing the open top,
a plurality of divider panels attached to the shell defining a plurality of chambers within the internal space, the plurality of chambers comprising:
a first chamber sized for stowage of the housing,
a second chamber sized for stowage of a water container, and
a third chamber sized for stowage of filters and condiments,
a pair of first handles attached singly to opposed ends of the shell, and
a second handle attached to the lid.
